(19) United States
(12) Patent Application Publication
(10) Pub. No.: US 2011/0181901 A1
(43) Pub. Date: Jul. 28, 2011

(54) ELECTROPHOTOGRAPHIC IMAGE FORMING APPARATUS AND CONTROL METHOD THEREFOR

(75) Inventor: Kazunori MIYAKE, Abiko-shi (JP)

(73) Assignee: CANON KABUSHIKI KAISHA, Tokyo (JP)

(21) Appl. No.: 13/009,126

(22) Filed: Jan. 19, 2011

(30) Foreign Application Priority Data
Jan. 22, 2010 (JP) 2010-011977
Jan. 13, 2011 (JP) 2011-004806

(51) Int. Cl. G06F 3/12

(52) U.S. Cl. 358/1.13

(57) ABSTRACT

An image forming apparatus that is capable of reducing the exchange frequency and increasing the lives of components without increasing a size and a cost. A reading unit reads images of a plurality of sheets of originals continuously. A storage unit stores the images of the originals read by the reading unit. An image forming unit performs image formation on sheets based on the images stored in the storage unit. A control unit controls driving and stopping of the image forming unit. The control unit controls the image forming unit so as to complete the image formation for N sheets by repeating an image forming state, in which the image formation for sheets fewer than N is performed continuously, and a stop state, in which the image formation stops, alternately, when the image forming unit performs the image formation while the reading unit reads N sheets of originals continuously.

### BACKGROUND OF THE INVENTION

1. Field of the Invention

The present invention relates to an electrophotographic image forming apparatus that forms an image, and a control method therefor.

2. Description of the Related Art

Conventionally, there is an electrophotographic image forming apparatus (a copier, a multifunctional peripheral device (MFP), etc.) that irradiates a photosensitive drum with laser to form an electrostatic latent image on a surface of the drum, and that transfers a toner image, which is obtained by developing the electrostatic latent image with toner, onto a sheet.

A four-drum tandem system that has four photosensitive drums arranged along with a transfer belt is known as the electrophotographic image forming apparatus. An image forming unit of the four-drum tandem system forms toner images of cyan (C), magenta (M), yellow (Y), and black (Bk) on surfaces of the four photosensitive drums, respectively, and then, forms a color image by transferring the toner images one by one onto a sheet.

FIG. 11 is a timing chart showing operations of an image reading unit and an operation of an image forming unit when a conventional image forming apparatus makes monochrome copies. In FIG. 11, (a) shows a timing of an original reading operation of the image reading unit. The image reading unit reads an image of each original conveyed from an original stacker one by one at a predetermined reading interval (an original-to-original interval). In FIG. 11, (b) shows a timing of an image forming operation of the image forming unit. In the example shown in FIG. 11, an original image reading rate that the image reading unit reads an original is equal to an image forming rate that the image forming unit forms a monochrome image on a sheet when making a monochrome copy. Therefore, at all times, the image forming unit can form an image after the image reading unit finishes reading an image.

FIG. 12 is a timing chart showing an operation of the image reading unit and an operation of the image forming unit when the conventional image forming apparatus makes color copies. In FIG. 12, (a) shows a timing of an original reading operation of the image reading unit, and (b) shows a timing of an image forming operation of the image forming unit. In the example shown in FIG. 12, since the image reading unit sequentially reads R-dots, G-dots, and B-dots on a color original when making a color copy, an original image reading rate of the image reading unit is one-third smaller than a color image forming rate of the image forming unit. Therefore, since the image reading unit is reading a next original at the time when the image forming unit finishes forming a copying image of the original read by the image reading unit, the image forming unit cannot form a next image, which increases the interval of image formation (the sheet-to-sheet interval).

It should be noted that a pre-process illustrated in FIG. 11 and FIG. 12 is a series of operations such as an activation of a drum motor that rotates the photosensitive drums, an activation of a polygon motor that rotates and drives a polygon mirror for scanning laser, and a temperature adjusting control of a fixing unit that fixes a toner image on a sheet.

In the image forming unit of the four-drum tandem system, the photosensitive drums and an intermediate transfer belt continue to be driven during a period until it starts forming an image of a next original, and the photosensitive drums contact the intermediate transfer belt while rotating. Therefore, components such as the photosensitive drums, cleaning blades that are press-contacted to the respective photosensitive drums, and the intermediate transfer belt tend to deteriorate. Unnecessary deterioration of such components increases exchange frequency of a photosensitive drum cartridge or a toner cartridge, or decreases a life of the intermediate transfer belt, and is not preferred. During this period, primary electrostatic chargers etc. are in action, which has effect on lives of the components.

The following technique has been proposed in order to cope with the problem of deterioration of the components of the image forming apparatus mentioned above (for example, see Japanese Laid-Open Patent Publication (Kokai) No. H3-288173 (JP H3-288173A)). The image forming apparatus disclosed in this publication employs a system that an image forming unit keeps a distance between a photosensitive drum and an intermediate transfer belt which are not used while rotating in the sheet-to-sheet interval from an end of image forming onto one sheet to a start of image forming onto a next sheet.

However, when keeping a distance between the photosensitive drum and the intermediate transfer belt which are not used in the sheet-to-sheet interval during which an image is not formed in order to cope with the problem of deterioration of the components of the image forming apparatus as proposed in the above-mentioned publication, a space to keep the distance and a driving mechanism are required. Therefore, the technique of the above-mentioned publication causes another problem that the size and the cost of the image forming apparatus increase when keeping the space and providing the driving mechanism in order to reduce the exchange frequency and to increase the lives of components such as the photosensitive drum of the image forming apparatus.

On the other hand, the sheet-to-sheet interval in the color copying can be reduced when the color image reading rate of the image reading unit is equal to the image forming rate of the image forming unit. However, such a method increases the cost of the image reading unit because of increasing the number of output channels of an image sensor and requiring a higher motor performance to increase a sensor moving speed and a sheet conveying speed.

### SUMMARY OF THE INVENTION

The present invention provides an image forming apparatus and a control method therefor, which are capable of reducing the exchange frequency and increasing the lives of components that constitute an image forming unit without increasing a size and a cost of the image forming apparatus.

Accordingly, a first aspect of the present invention provides an image forming apparatus in which a processing rate for reading an original is lower than a processing rate for forming an image, comprising a reading unit configured to read images of a plurality of sheets of originals continuously, a storage unit configured to store the images of the originals read by the reading unit, an image forming unit configured to perform image formation on sheets based on the images stored in the storage unit, a control unit configured to control driving and stopping of the image forming unit, wherein the control unit controls the image forming unit so as to complete the image formation for N sheets by repeating an image forming condition, in which the image formation for sheets fewer than N is performed continuously, and a stop condition, in which the image formation stops, alternately, when the image forming unit performs the image formation while the reading unit reads N sheets of originals continuously.

Accordingly, a second aspect of the present invention provides an image forming apparatus comprising an image forming unit configured to perform image formation on a sheet based on an image of an original read by a reading unit, a control unit configured to control driving and stopping of the image forming unit, wherein the control unit controls the image forming unit so as to complete the image formation for N sheets by repeating an image forming condition, in which the image formation for sheets fewer than N is performed continuously, and a stop condition, in which the image formation stops, alternately, when the image forming unit performs the image formation while the reading unit reads N sheets of originals continuously.

Accordingly, a third aspect of the present invention provides an image forming apparatus in which a processing rate for conveying and reading an original is lower than a processing rate for forming an image, comprising an image reading unit configured to read a plurality of sheets of originals continuously, a storage unit configured to store image data of the image read by the image reading unit, an image forming unit configured to form an image on a sheet based on the image data, and a control unit configured to control operations of the image reading unit and the image forming unit, wherein the control unit starts an operation of the image forming unit when image data of a predetermined number (2 or more) of sheets of originals that have not been formed is stored in the storage unit during the operation for reading a plurality of sheets of originals by the image reading unit, and stops the operation of the image forming unit in response to lack of image data of one sheet of an original that has not been formed in the storage unit after starting the operation, and wherein the control unit repeats the start and the stop of the operation alternately.

Accordingly, a fourth aspect of the present invention provides a control method for an image forming apparatus that includes an image reading unit that reads a plurality of sheets of originals continuously, a storage unit that stores image data of the image read by the image reading unit, and an image forming unit that forms an image on a sheet based on the image data, in which a processing rate for conveying and reading an original is lower than a processing rate for forming an image, the control method comprising a determination step of determining whether image data of a predetermined number (2 or more) of sheets of originals that have not been formed is stored in the storage unit during the operation for reading a plurality of sheets of originals by the image reading unit, a starting step of starting an operation of the image forming unit when it is determined, in the determination step, that the image data of the predetermined number of sheets of originals is stored, and a stopping step of stopping the operation of the image forming unit when the storage unit does not store image data of one sheet of an original that has not been formed after starting the operation, wherein the starting step and the stopping step are repeated alternately during reading a plurality of sheets of originals continuously.

According to the present invention, deterioration of the components that constitute the image forming unit can be reduced without increasing the size and the cost of the image forming apparatus, which reduces the exchange frequency and increases the lives of the components.

Further features of the present invention will become apparent from the following description of exemplary embodiments with reference to the attached drawings.

### BRIEF DESCRIPTION OF THE DRAWINGS

FIG. 1 is a view showing an internal configuration of an image forming apparatus according to a first embodiment of the present invention.

FIGS. 2A, 2B, and 2C are three parts of a block diagram showing an electrical configuration of the image forming apparatus in FIG. 1.

FIG. 3 is a timing chart showing operations of an original detection sensor, an image reading unit, and an image forming unit when making color copies of six sheets of originals by the image forming apparatus in FIG. 1.

FIG. 4 is a flowchart showing a process executed by a CPU of an image processing controller unit when making color copies by the image forming apparatus in FIG. 1.

FIG. 5 is a flowchart showing a process executed by a CPU of a control unit when making color copies by the image forming apparatus in FIG. 1.

FIG. 6 is a timing chart showing operations of an original detection sensor, an image reading unit, and an image forming unit when making color copies of ten sheets of A4 size originals by an image forming apparatus according to a second embodiment of the present invention.

FIG. 7 is a timing chart showing operations of the original detection sensor, the image reading unit, and the image forming unit when making color copies of twenty sheets of AS size originals by the image forming apparatus according to the second embodiment of the present invention.

FIG. 8 is a timing chart showing operations of the original detection sensor, the image reading unit, and the image forming unit when making color copies of A4 size originals with a 2-in-1 reduction layout by the image forming apparatus according to the second embodiment.

FIG. 9 is a flowchart showing a process by a CPU of an image processing controller unit when making color copies by the image forming apparatus according to the second embodiment.

FIG. 10 is a flowchart showing a process by a CPU of a control unit when making color copies by the image forming apparatus according to the second embodiment.

FIG. 11 is a timing chart showing operations of an image reading unit and an image forming unit when making monochrome copies by a conventional image forming apparatus.

FIG. 12 is a timing chart showing operations of an image reading unit and an image forming unit when making color copies by a conventional image forming apparatus.

### DESCRIPTION OF THE EMBODIMENTS

Hereafter, embodiments according to the present invention will be described in detail with reference to the drawings.

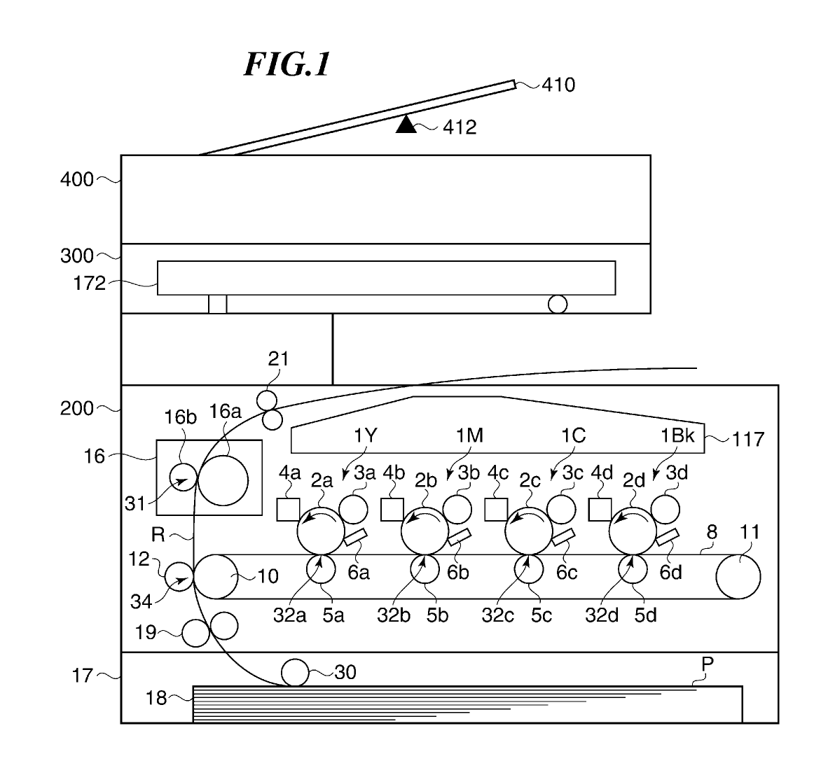

FIG. 1 is a view showing an internal configuration of an image forming apparatus according to a first embodiment of the present invention.

In FIG. 1, the image forming apparatus comprises an image forming unit 200, an image reading unit 300, and an original conveyance unit 400, and an image is formed by transferring a toner image, which is formed by developing an electrostatic latent image formed by scanning a photoconductor with a laser beam, onto a sheet (plain paper, thick paper, and an OHP sheet are included). The image forming apparatus of this embodiment forms an image, when making a color copy (color image formation), under the condition where a processing speed in connection with productivity of an original reading including conveyance of an original (an image reading rate) is smaller than a processing speed in connection with productivity of image formation (an image forming rate).

The original conveyance unit 400 continuously conveys originals stacked on an original tray 410 one by one toward the original reading unit 200. It should be noted that the original conveyance unit 400 is provided with an original detection sensor 412, which detects whether any original is stacked on the original tray 410 or not. The original reading unit 300 reads an image of the original conveyed by the original conveyance unit 400 using an image sensor 172.

The image forming unit 200 is provided with four image forming units 1Y, 1M, 1C, and 1Bk, an intermediate transfer belt 8, a fixing unit 16, a paper feeding unit 17, and a laser unit 117. The original conveyance unit 400 conveys the original set to the original tray 410 to the image reading unit 300 one by one. The image reading unit 300 reads an image on the original conveyed. Details of the image reading unit 300 and the original conveyance unit 400 will be described later. The image forming units 1Y, 1M, 1C, and 1Bk are arranged at constant intervals and constitute a four-drum tandem system. The image forming units 1Y, 1M, 1C, and 1Bk transfer a yellow image, a magenta image, a cyan image, and a black image to the intermediate transfer belt 8, respectively.

The image forming unit 1Y is provided with an electrophotography photoconductor of a drum type (referred to as a photosensitive drum, hereafter) 2a as an image bearing member. Around the photosensitive drum 2a, a primary electrostatic charger 3a, a development device 4a, a transfer roller 5a, and a cleaning blade 6a are arranged. Since the configurations of the image forming units 1M, 1C and 1Bk are also the same as that of the image forming unit 1Y, descriptions are omitted. In FIG. 1, subscripts b, c, and d of the reference numerals show the same elements of the image forming units 1M, 1C, and 1Bk, respectively.

The paper feeding unit 17 comprises a paper feeding cassette 18, a pickup roller 30, and paper feeding roller and guide (not shown). The pickup roller 30 sends out paper P one by one from the paper feeding cassette 18. The paper feeding roller and the paper feeding guide convey the paper P to a registration roller pair 19. The registration roller pair 19 sends out the paper P to a secondary transfer unit 34 in synchronism of image formation timings of the image forming units 1Y, 1M, 1C, and 1Bk. The pickup roller 30, the registration roller pair 19, the paper feeding roller, the sheet feeding guide, etc. constitute the conveyance unit.

The photosensitive drums 2a, 2b, 2c, and 2d are driven by a drive mechanism (not shown) to rotate at a predetermined process speed in directions of arrows, respectively. The primary electrostatic chargers 3a, 3b, 3c, and 3d uniformly charge the surfaces of the photosensitive drums 2a, 2b, 2c, and 2d with charging bias voltage applied from a charging bias power supply (not shown) in a predetermined potential in the negative polarity, respectively.

The laser unit 117 comprises a laser emitting section that emits a laser beam according to time-series digital pixel signals (PWM data) of image information supplied from a below-mentioned image processing controller unit, a polygon mirror, an fθ lens, a reflective mirror, etc. The laser unit 117 irradiates the surfaces of the photosensitive drums 2a, 2b, 2c, and 2d with laser beams so as to expose and form electrostatic latent images on the surfaces of the photosensitive drums corresponding to the image information.

The development devices 4a, 4b, 4c, and 4 contains yellow toner, cyan toner, magenta toner, and black toner, respectively. The development devices 4a, 4b, 4c, and 4d develop the electrostatic latent images formed on the photosensitive drums as toner images by adhering the toner of the respective colors. The intermediate transfer belt 8 runs between a secondary transfer opposite roller 10 and a tension roller 11, is driven circularly. The toner images formed on the photosensitive drums are transferred onto the intermediate transfer belt 8.

Transfer rollers 5a, 5b, 5c, and 5d are arranged so as to contact with the photosensitive drums 2a, 2b, 2c, and 2d via the intermediate transfer belt 8, respectively. The contact points constitute primary transfer points 32a, 32b, 32c, and 32d. The toner images formed on the photosensitive drums are sequentially transferred and overlapped on the intermediate transfer belt 8 at the primary transfer points 32a, 32b, 32c, and 32d. After transferring, the cleaning blades 6a, 6b, 6c, and 6d scrape the toner remained on the photosensitive drums.

A secondary transfer roller 12 is arranged so as to contact with the secondary transfer opposite roller 10 via the intermediate transfer belt 8. The contact point constitutes a secondary transfer point 34. The toner image transferred onto the intermediate transfer belt 8 is transferred onto the paper conveyed from the paper feeding unit 17 at the secondary transfer point 34.

The fixing unit 16 fixes the toner image transferred onto the paper that is conveyed along a paper path R by heating and pressurization. The paper on which the toner image has been fixed is ejected outside the apparatus by an eject roller pair 21. The image using the toner of the respective colors is formed by the above-mentioned process.

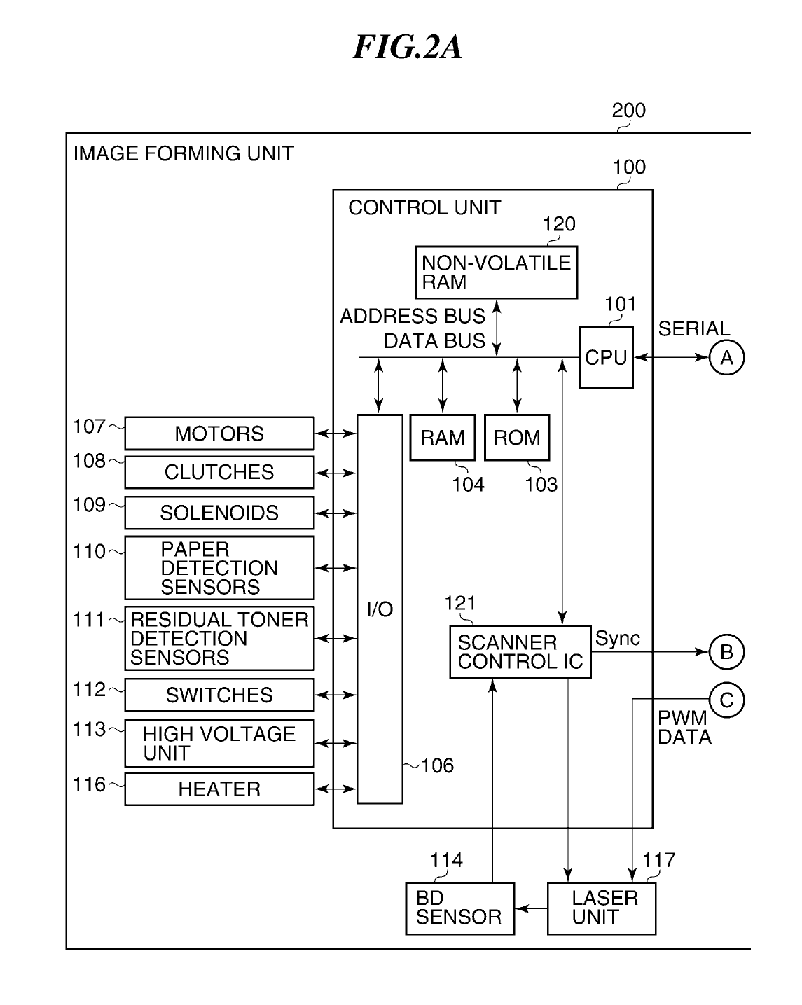

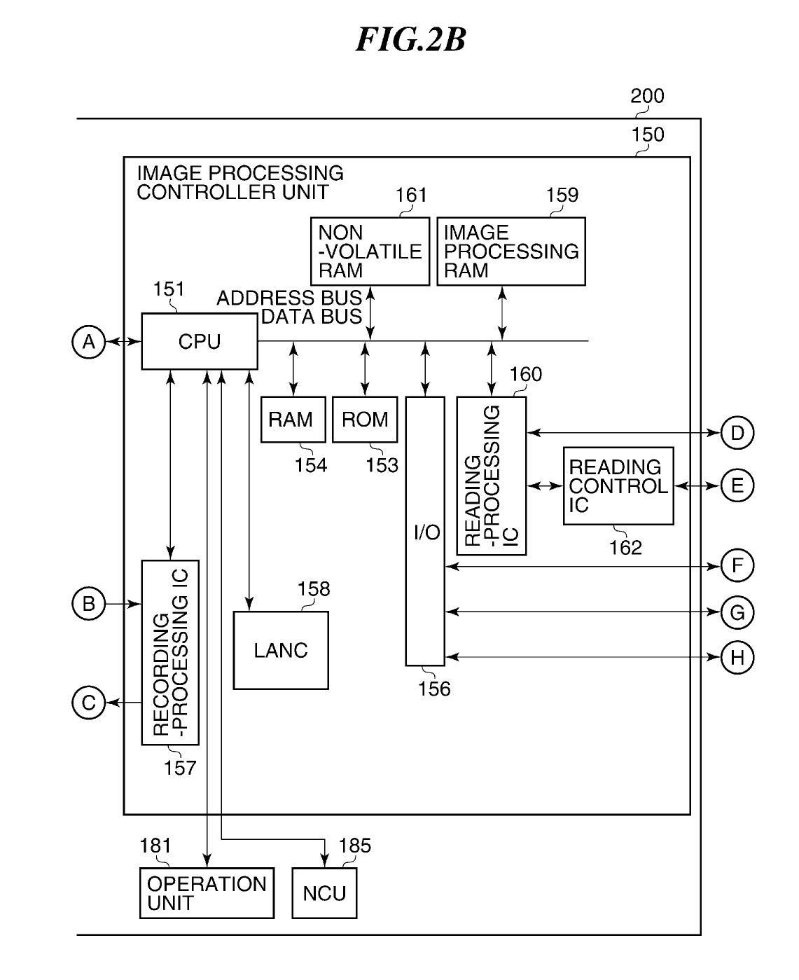

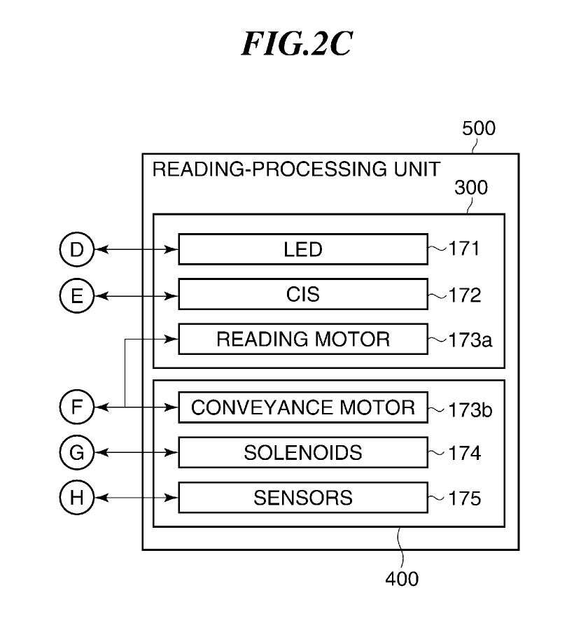

FIGS. 2A, 2B, and 2C are three parts of a block diagram showing an electrical configuration of the image forming apparatus in FIG. 1. In FIGS. 2A, 2B, and 2C, the image forming unit 200 of the image forming apparatus is provided with a control unit 100 and an image processing controller unit 150. A reading-processing unit 500 comprises the image reading unit 300 and the original conveyance unit 400.

The control unit 100 manages image formation control (control in connection with conveyance of paper, generation of high-voltage, emission of laser, charging, development, transfer, fixing, etc.) of the image forming unit 200. A CPU 101 reads control procedures (control programs) of the image forming apparatus from a ROM 103 one by one, and executes them. The ROM 103 stores the control programs. A RAM 104 is used as an input data storage area, a working storage area, etc. A non-volatile RAM 120 is used as a storage area for parameters in connection with the image forming operation of the image forming apparatus. Motors 107, clutches 108, solenoids 109, paper detection sensors 110, residual toner detection sensors 111, switches 112, a high voltage unit 113, and a heater 116 are connected to an I/O interface 106.

The motors 107 drive a paper feeding system, a paper conveyance system, and an optical system. The paper detection sensors 110 detect the paper that is conveyed along the paper path. The residual toner detection sensors 111 detect the residual quantities of toner in the development devices 4a through 4d. The switches 112 detect home positions of the driven targets such as the photosensitive drums. Output signals of the paper detection sensors 110, the residual toner detection sensors 111, and the switches 112 are inputted into the I/O interface 106. The high voltage unit 113 supplies the high voltage alternating current to the primary electrostatic chargers 3a through 3d, the development devices 4a through 4d, and the transfer rollers 5a through 5d. The prescribed voltage alternating current is supplied to the heater 116.

The image processing controller unit 150 executes image processing to the image signal outputted from external connection devices such as the reading-processing unit 500 and a PC, and generates the above-mentioned PWM data. The image processing controller unit 150 executes image processing to the image signal outputted from the reading-processing unit 500, and stores image data into a recording medium connected to an external connection device or an operation unit 181.

A CPU 151 sequentially reads control programs from a ROM 153, and executes them. The CPU 151 controls the operation unit 181 and a network control unit (NCU) 185 that manages control of a facsimile function. The operation unit 181 is provided with various buttons including a copy button and a display unit.

In the image forming apparatus of this embodiment, an enlarged/reduction layout of the image formed on paper, magnification when enlarging/reducing an original image, and a double-sided copy in which images are formed on both sides of paper, etc. can be set through an operation on the operation unit 181. Moreover, a 1-to-1 copy where an image read from one sheet of an original is printed on one sheet of paper, and a 2-in-2 copy where images read from two sheets of originals are reduced and printed on one sheet of paper can be set through an operation on the operation unit 181.

The ROM 153 stores an image processing control program. A RAM 154 is used as an input data storage area, a working storage area, etc. A recording-processing IC 157 executes processing to the image signals transmitted from the reading-processing unit 500 and the external connection devices, and generates the above-mentioned PWM data. The recording-processing IC 157 turns on and turns off the laser emitting section (not shown) of the laser unit 117 according to the image data.

In the laser unit 117, a BD (Beam Detector) sensor 114 as a light receiving sensor is arranged in a non-image region (a region outside a region in which the laser beam that irradiates the photosensitive drum travels) of the laser emitting section to detect a laser emitting condition. A scanner control IC 121 controls rotation of the polygon motor (included in the motors 107) that drives the polygon mirror for scanning a laser beam based on the BD signal outputted from the BD sensor 114. The scanner control IC 121 outputs an image synchronizing signal to the image processing controller unit 150.

A reading motor 173a mounted in the image reading unit 300, a conveyance motor 173b mounted in the original conveyance unit 400, the solenoids 174, and the sensors 175 are connected to an I/O interface 156. A reading-processing IC 160 controls an emission of an LED unit 171, controls to drive a contact image sensor (referred to as a CIS, hereafter) 172 via a reading control IC 162, and processes image data outputted from the CIS 172.

An image processing RAM 159 is used as a storage area that stores image data temporarily, when processing the image data read from an original by the image reading unit 300 or the image data received from the external connection devices. A non-volatile RAM 161 is used as a storage area for parameters in connection with the image processing. A LAN controller 158 controls communication with the external connection devices connected via a LAN cable.

The CPU 101 of the control unit 100 and the CPU 151 of the image processing controller unit 150 are connected via a serial communication line. The CPU 101 and the CPU 151 communicate to each other and control an output timing of the image data to the image forming unit, starting/finishing the apparatus, and a mode shift of the apparatus between a normal operation mode and a sleep mode.

The image reading unit 300 is possible to read a color image, and is provided with the reading motor 173a, the LED unit 171 that consists of a red (R) LED, a green (G) LED, and a blue (B) LED, and the image sensor 172. When reading a color image of an original, the R-LED, G-LED, and B-LED are sequentially turned on, and the image sensor 172 reads original images of the respective colors. Namely, the image sensor 172 reads three times for every one main scanning line. When reading a monochrome image of an original, the G-LED is turned on and the image sensor 172 reads an original image. Namely, the image sensor 172 reads once for every one main scanning line. Therefore, when a color image is read in the same resolution as a monochrome image, the image reading rate at the time of color image formation is one-third smaller than the image reading rate at the time of monochrome image formation (black-and-white image formation).

The original conveyance unit 400 is provided with the conveyance motor 173b, the solenoids 174, and the sensors 175, and continuously conveys a plurality of originals stacked on the original tray 410 to the image reading unit 300 one by one. The sensors 175 include the original detection sensor 412 that detects whether an original is set to the original tray 410, and a sensor that is used to detect a size of an original according to a time period over which the original passes through the sensor position on the original conveyance path.

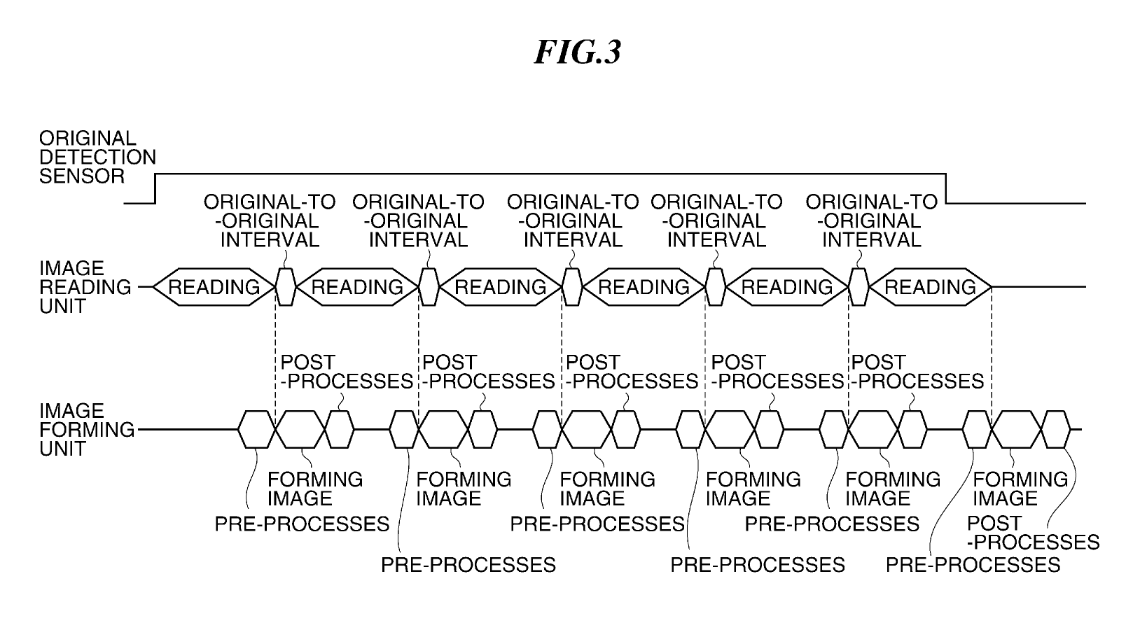

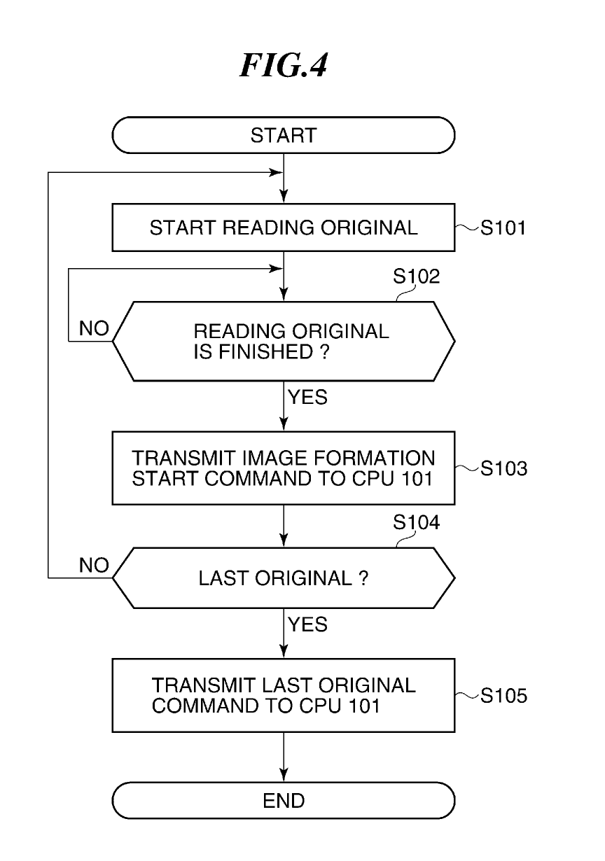

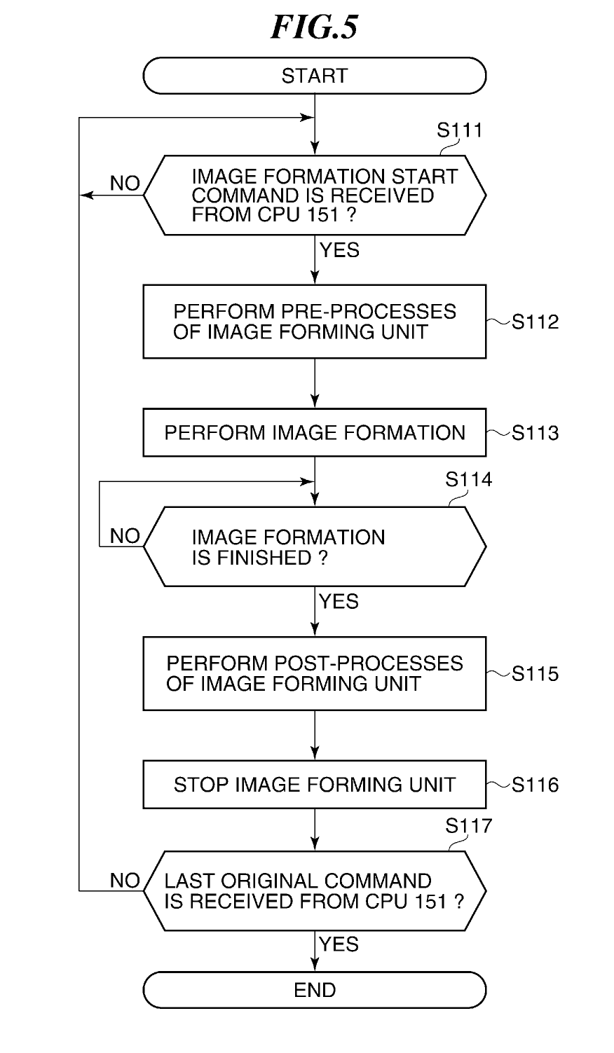

Next, an operation of the image forming apparatus of this embodiment provided with the above-mentioned configuration will be described with reference to FIG. 3, FIG. 4, and FIG. 5.

FIG. 3 is a timing chart showing operations of the original detection sensor, the image reading unit, and the image forming unit when making color copies of six sheets of originals by the image forming apparatus, for example. In FIG. 3, when a user pushes the copy button in the operation unit 181 of the image forming apparatus, the image reading unit 300 starts to read a first original set to the original tray 410 of the original conveyance unit 400. The image forming unit 200 executes a pre-process of the intermediate transfer belt 8 before the image reading unit 300 finishes reading the first original, and starts an image forming operation that copies an image of the first original when the reading of the first original is finished. And after the image formation is completed, the image forming unit 200 performs post-processes such as cleaning of the intermediate transfer belt 8, and stops.

The stop of the image forming unit 200 (a halt of image formation) in this embodiment is defined as stops of operations of elements that constitute the image forming unit 200. That is, the operations of the paper conveyance system, the polygon motor, the photosensitive drums 2a through 2d, the intermediate transfer belt 8, etc. are stopped, the supply of high voltage used for charging, developing, and transferring is stopped, and the temperature control for the fixing unit 16 is stopped. In the following description, the stop of the image forming unit 200 will be used in the same definition.

In this embodiment, the pre-processes are preparation operations for starting image formation such as starting of the drum motors that rotate the photosensitive drums, starting of the polygon motor (not shown) that rotates the polygon mirror for scanning a laser beam, and a temperature adjusting control of the fixing unit 16. The post-processes are finishing operations such as cleaning of the intermediate transfer belt 8.

As shown in FIG. 3, the image reading unit 300 reads a second original while the image forming unit 200 stops. The image forming unit 200 executes the pre-processes before the image reading unit 300 finishes reading the second original, and starts the image forming operation that copies an image of the second original after the pre-processes are finished. After finishing the image formation of the second original, the image forming unit 200 performs the post-processes such as the cleaning of the intermediate transfer belt 8, and stops the operation. After that, the image forming apparatus continues the above-mentioned operations until the image formation that copies an image of the last original (a sixth original) among the six originals set to the original tray 410 of the original conveyance unit 400 is completed.

That is, when reading the originals conveyed continuously, the driving of the photosensitive drums by a driving mechanism is stopped after the image forming unit 200 completes the formation of the image of n-th original to paper and after a finishing process for finishing operation of the image forming unit 200 is completed. Before the image reading unit 300 completes reading of the (n+1)th original, the driving of the photosensitive drums by the driving mechanism restarts and the preparation operation for the image formation by the image forming unit 200 starts. The image forming apparatus of this embodiment is controlled so as to repeat the above-mentioned operations. It should be noted that n is 1 or a natural number larger than 1.

FIG. 4 is a flowchart showing a process executed by the CPU 151 of the image processing controller unit 150 when making color copies by the image forming apparatus in FIG. 1. FIG. 5 is a flowchart showing a process executed by the CPU 101 of the control unit 100 when making color copies by the image forming apparatus in FIG. 1.

In FIG. 4, the CPU 151 of the image processing controller unit 150 starts reading originals as follows when the user pushes the copy button in the operation unit 181. The CPU 151 starts reading the originals set to the original tray 410 of the original conveyance unit 400 by the image reading unit 300 (step S101).

Next, the CPU 151 determines whether the image reading unit 300 has finished the reading of one sheet of the original (step S102). When the reading of one sheet of the original has been finished, the CPU 151 transmits an image formation start command that shows an image formation start to the CPU 101 of the control unit 100 (step S103).

Next, the CPU 151 determines whether the original read by the image reading unit 300 is the last original of the plurality of originals set to the original tray 410 based on the output signal from the original detection sensor 412 (step S104). When the read original is not the last original, the CPU 151 starts reading a next original by the image reading unit 300 (step S101), and repeats this operation until the last original comes.

On the other hand, when the read original is the last original, the CPU 151 transmits a last original command showing that the current original is the last one to the CPU 101 of the control unit 100 (step S105). This finishes the original reading operation.

In FIG. 5, the image forming unit 200 maintains a stopped state until the CPU 101 of the control unit 100 receives the image formation start command transmitted from the CPU 151 of the image processing controller unit 150. When receiving the image formation start command from the CPU 151 of the image processing controller unit 150 (YES in step S111), the CPU 101 executes the pre-processes such as the temperature adjusting control of the fixing unit 16 and the starting of the polygon motor in the image forming unit 200 (step S112). Then, the CPU 101 starts the image formation by the image forming unit 200 (step S113).

Next, the CPU 101 determines whether the image forming unit 200 has finished the image formation to one sheet of paper based on the above-mentioned image formation start command (step S114). After the image forming unit 200 finishes the image formation, the CPU 101 executes the post-processes such as cleaning of the intermediate transfer belt 8 (step S115), and stops the image forming unit 200 (step S116). The definition of the stop of the image forming unit 200 has been described above.

Next, the CPU 101 determines whether the last original command showing that the current original is the last one has been received from the CPU 151 of the image processing controller unit 150 (step S117). When the last original command is not received from the CPU 151 of the image processing controller unit 150, the CPU 101 waits for receiving a next image formation start command from the CPU 151 (step S111).

When receiving the next image formation start command from the CPU 151 of the image processing controller unit 150, the CPU 101 executes the pre-processes of the image forming unit 200 again (step S112), and starts the image formation by the image forming unit 200 (step S113). The CPU 101 continues the above operation until receiving the last original command from the CPU 151 of the image processing controller unit 150, and completes the image forming operation when the last original command is received.

As described in the background of the invention, components of the conventional image forming unit such as photosensitive drums and cleaning blades are always operating when reading originals even during original reading conventionally also during the period between the end of the image formation to one sheet of paper and the start of the image formation to the next sheet of paper. Therefore, the components such as the photosensitive drums and the cleaning blades are deteriorated even during the period when the image forming unit does not perform exposure, development, transfer, etc.

As compared with this, the first embodiment performs the operations shown in FIG. 3, FIG. 4, and FIG. 5 mentioned above, when reading the plurality of originals continuously and forming color images (color copies). Since the image forming unit 200 can stop during the image reading unit 300 reads the originals, operating time other than the image formation of the image forming unit 200 can be significantly reduced, and the deterioration of the photosensitive drums, the cleaning blades, etc. can be reduced.

As described above in detail, this embodiment has the following functions and effects. The CPU 101 of the control unit 100 of the image forming apparatus performs the following operation. When reading the originals continuously, the driving of the photosensitive drums by the driving mechanism is stopped after the image forming unit 200 completes the formation of the image of n-th original to paper and after a finishing process for finishing operation of the image forming unit 200 is completed. Before the image reading unit 300 completes reading of the (n+1)th original, the driving of the photosensitive drums by the driving mechanism restarts and the preparation operation for the image formation by the image forming unit 200 starts. The image forming apparatus of this embodiment is controlled so as to repeat the above-mentioned operations.

Accordingly, the deterioration of the components (the photosensitive drums, the cleaning blades, etc.) that constitute the image forming unit of the image forming apparatus can be reduced without increasing the size and the cost of the image forming apparatus. This can decrease the exchange frequency of the photosensitive drum cartridge and the toner cartridge, and can increase the life of the intermediate transfer belt.

In the first embodiment, the pre-processes and the post-processes are performed whenever the image formation of one sheet is performed. On the other hand, a second embodiment of the present invention decreases the number of times of the pre-processes and the post-processes as compared with that in the first embodiment. Since the other elements of this embodiment are identical to the corresponding elements in the above-mentioned first embodiment (FIG. 1 and FIGS. 2A, 2B, 2C), their descriptions are omitted.

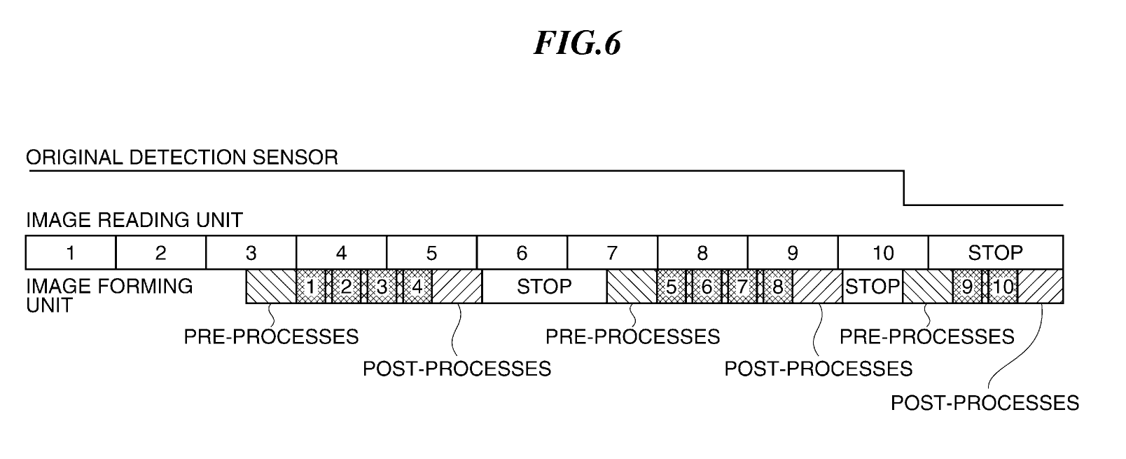

FIG. 6 is a timing chart showing operations of the original detection sensor, the image reading unit, and the image forming unit when making color copies of ten sheets of A4 size originals by the image forming apparatus according to this embodiment.

In FIG. 6, when a user pushes the copy button in the operation unit 181 of the image forming apparatus, the image reading unit 300 starts to read an original set to the original tray 410 of the original conveyance unit 400. The CPU 151 of the image processing controller unit 150 of the image forming unit 200 detects the size of the reading original according to a time period over which the original passes through the sensor position on the original conveyance path. The CPU 151 determines timing for starting image formation based on the original size and copy modes (for example, an N-in-1 mode to copy images of N sheets of originals to a recording sheet side-by-side, a recording sheet size, a copy magnification, etc.) that are set by the user via the operation unit 181. This timing is data indicating the number of original sheets of which images are stored into the RAM 159 that is needed to start the image formation (data about the number of sheets for starting image formation). In FIG. 6, when the image data of three sheets of originals are stored into the RAM 159, the image formation is started. This data about the number of sheets for starting image formation is predetermined for every combination of an original size and a copy mode based on a difference between the reading rate of the image reading unit 300 and the image forming rate of the image forming unit, and is stored in the ROM 103 as a table.

When making color copies of ten sheets of A4 size originals in this embodiment, the data about the number of sheets for starting image formation is three sheets. Therefore, when the image reading unit 300 stores the image of the originals up to a third sheet into the RAM 159, the image forming unit 200 starts the image forming operation. The image reading unit 300 performs the reading operation continuously until reading the last original (original of the tenth sheet). The image forming unit 200 starts the pre-processes so that the pre-processes are finished before the timing of which the image reading unit 300 finishes the reading of a third original. The image forming unit 200 starts the image formation to copy the image of the first original after the pre-processes are completed. It should be noted that the finishing timing of the pre-processes may shift slightly.

Since the image reading unit 300 completes the reading of the originals up to a fourth original during the image formation to copy the images of the first through third originals, the image forming unit 200 continuously forms the images up to the fourth original (the regular number of continuous originals that have been read). When the image forming unit 200 finishes the image formation to copy the image of the fourth original, the image reading unit 300 is reading a fifth original. In addition, spooling of the page data of the fifth original to the image-processing RAM 159 of the image forming unit 200 is not completed. Therefore, the image forming unit 200 performs post-processes such as cleaning of the intermediate transfer belt 8, and stops.

Next, the image forming unit 200 restarts the pre-processes so that the pre-processes are finished before the timing of which the image reading unit 300 completes the reading of the three sheets of originals of which images have not yet formed, and restarts the image forming operation after finishing the pre-processes. In this case, the three sheets of originals of which images have not yet formed correspond to the fifth through seventh originals. Since the image reading unit 300 completes the reading of the originals up to an eighth original during the image formation to copy the images of the fifth through seventh originals (the regular number of continuous originals that follow the above-mentioned regular number of originals), the image forming unit 200 continuously forms the images up to the eighth original. When the image forming unit 200 finishes the image formation to copy the image of the eighth original, the image reading unit 300 is reading a ninth original. In addition, spooling of the page data of the ninth original to the image-processing RAM 159 is not completed. Therefore, the image forming unit 200 performs the above-mentioned post-processes, and stops.

When the original conveyance unit 400 feeds a tenth original, and when the tenth original is recognized as the last original based on detection by the original detection sensor 412, the image forming unit 200 performs the pre-processes, and starts the image forming operation. The image forming unit 200 performs the image formation to copy the image of the ninth original and the image formation to copy the image of the tenth original, and finishes the image forming operation after completing the post-processes.

Although the embodiment shows the example where the image formation to copy the image of the first original starts in response to the reading of the third original, the control is not limited to this. The image formation to copy the image of the first original may start in response to the reading of the fourth original.

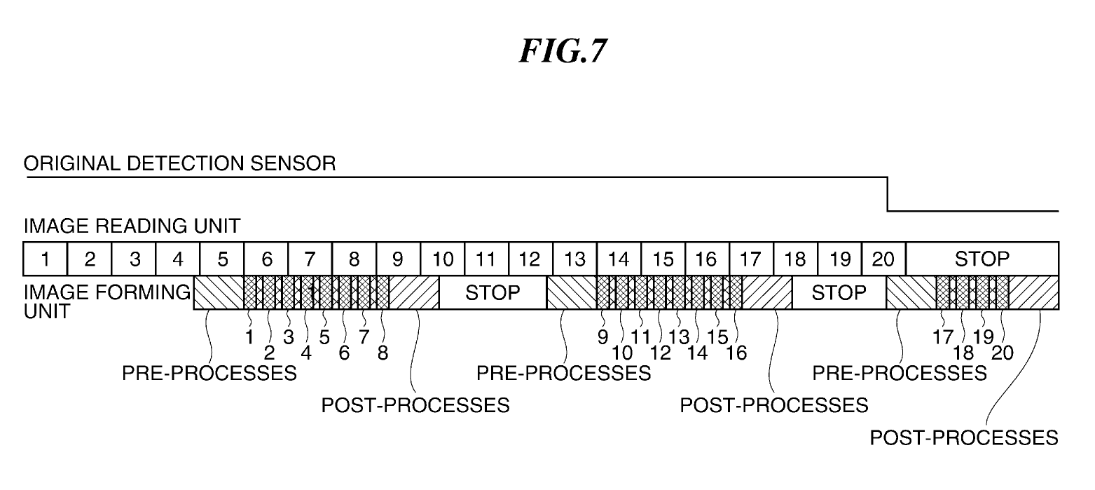

FIG. 7 is a timing chart showing operations of the original detection sensor, the image reading unit, and the image forming unit when making color copies of twenty sheets of A5 size originals onto sheets of A5 size by the image forming apparatus according to the second embodiment. Since the time required to form an image of A5 size is shorter than the time required forming an image of A4 size, the number of sheets to which the image forming unit 200 continuously copies originals of A5 size is more than the number of sheets to which originals of A4 size are copied.

In FIG. 7, when a user pushes the copy button in the operation unit 181 of the image forming apparatus, the image reading unit 300 starts to read an original set to the original tray 410 of the original conveyance unit 400. The CPU 151 of the image processing controller unit 150 of the image forming unit 200 detects the size of the reading original according to a time period over which the original passes through the sensor position on the original conveyance path as described with reference to FIG. 4 and FIG. 5. Moreover, the CPU 151 determines the data about the number of sheets for starting image formation based on the size of original and the copy mode. In the case of FIG. 7, the data about the number of sheets for starting image formation is five sheets.

When making the color copies of twenty sheets of A5 size originals in this embodiment, the image forming unit 200 starts image forming operation at the time when the image reading unit 300 completes the reading of five sheets of originals. The image reading unit 300 performs the reading operation continuously until reading the last original (original of a twentieth sheet).

The image forming unit 200 starts the pre-processes so that the pre-processes are finished before the image reading unit 300 finishes reading the fifth original, and starts the image formation to copy the image of the first original after the pre-processes are finished. The image forming unit 200 continues the image formation until the image formation for all image data of the originals stored in the RAM 159 is completed. Here, the image formation is continuously performed up to the eighth original. When the image forming unit 200 finishes the image formation to copy the image of the eighth original, the image reading unit 300 is reading the ninth original. In addition, spooling of the page data of the ninth original to the image-processing RAM 159 is not completed. Therefore, the image forming unit 200 performs post-processes such as cleaning of the intermediate transfer belt 8, and stops.

Next, the image forming unit 200 restarts the image formation when the image data of five sheets of originals of which images are not formed is stored in the RAM 159. In this case, the image formation is restarted at the time when the image data of a thirteenth original is stored in the RAM 159. The image forming unit 200 starts the pre-processes so that the pre-processes are finished at the time when the image reading unit 300 finishes reading the thirteenth original, and starts the image formation after the pre-processes are finished. The image forming unit 200 continues the image formation until the image formation for all image data of the originals stored in the RAM 159 is completed. Here, the image formation is continuously performed up to the sixteenth original. When the image forming unit 200 finishes the image formation to copy the image of the sixteenth original, the image reading unit 300 is reading the seventeenth original. In addition, spooling of the page data of the seventeenth original to the image-processing RAM 159 is not completed. Therefore, the image forming unit 200 performs the above-mentioned post-processes, and stops.

When the original conveyance unit 400 feeds the twentieth original, and when the twentieth original is recognized as the last original based on detection by the original detection sensor 412, the image forming unit 200 performs the pre-processes, and starts the image forming operation. The image forming unit 200 performs the image formation to copy the images of the seventeenth through twentieth originals, and finishes the image forming operation after completing the post-processes.

Although the embodiment shows the control example where the image formation to copy the image of the first original starts in response to the reading of the fifth original as a typical example, the control example is not limited to this. The image formation to copy the image of the first original may start in response to the reading of the sixth original.

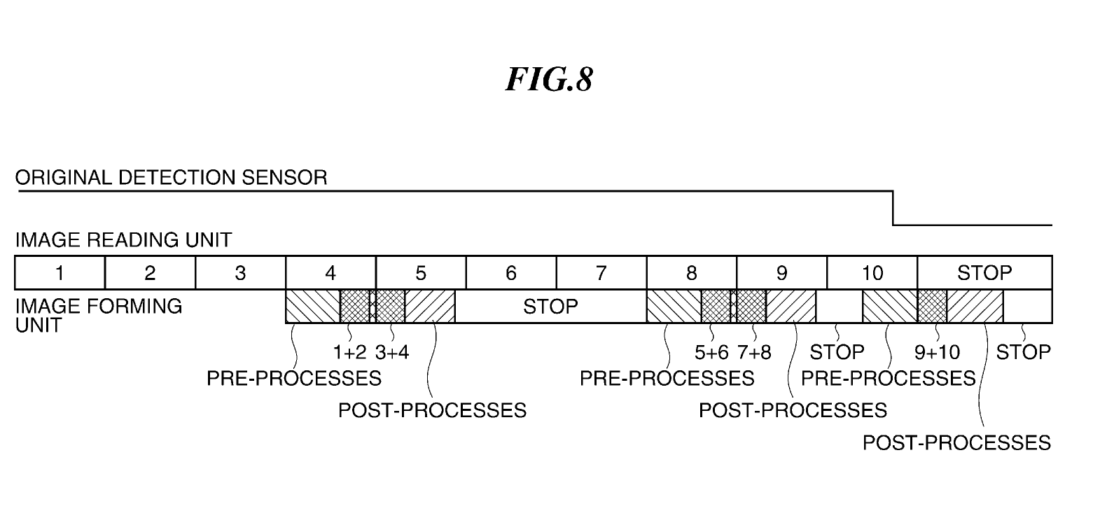

FIG. 8 is a timing chart showing operations of the original detection sensor, the image reading unit, and the image forming unit when making color copies of A4 size originals in the 2-in-1 mode in which two sheets of originals are copied into one recording sheet side by side by the image forming apparatus according to the second embodiment.

In FIG. 8, when the user pushes the copy button in the operation unit 181 of the image forming apparatus, the image reading unit 300 starts to read an original set to the original tray 410 of the original conveyance unit 400. The CPU 151 of the image processing controller unit 150 of the image forming unit 300 detects the size of the reading original according to a time period over which the original passes through the sensor position on the original conveyance path. Moreover, the CPU 151 determines the data about the number of sheets for starting image formation based on the size of original and the copy mode. In FIG. 8, the data about the number of sheets for starting image formation is three sheets.

When copying A4 size originals in the 2-in-1 mode in this embodiment, when the image reading unit 300 completes the reading of the three sheets of originals, the image forming unit 200 starts the pre-processes and starts the image forming operation. The image reading unit 300 performs the reading operation continuously until reading the last original (original of the tenth sheet).

The image forming unit 200 starts the pre-processes at the time when the image reading unit 300 finishes the reading of the third original, and starts forming an image in which the image of the first original and the image of the second original are arranged side by side. Next, an image in which the image of the third original and the image of the fourth original are arranged side by side is formed.

When the image forming unit 200 finishes the image formation to copy the images of the third and fourth originals, the image reading unit 300 is reading the fifth original. In addition, spooling of the page data of the fifth and sixth originals to the image-processing RAM 159 is not completed. Therefore, the image forming unit 200 performs the post-processes such as cleaning of the intermediate transfer belt 8, and stops.

Next, when the image reading unit 300 completes the reading of three sheets of originals of which images have not been formed, the image forming unit 200 restarts the pre-processes, and starts the image forming operation. In this case, the pre-processes are started when the reading of the seventh original is finished. The image forming unit 200 forms an image in which the image of the fifth original and the image of the sixth original are arranged side by side, and an image in which the image of the fifth original and the image of the sixth original are arranged side by side.

When the image forming unit 200 finishes the image formation to copy the images of the seventh and eighth originals, the image reading unit 300 is reading the ninth original. In addition, spooling of the page data of the ninth and tenth originals to the image-processing RAM 159 is not completed. Therefore, the image forming unit 200 performs the above-mentioned post-processes, and stops.

When the original conveyance unit 400 feeds the tenth original, and when the tenth original is recognized as the last original based on detection by the original detection sensor 412, the image forming unit 200 starts the pre-processes so that the pre-processes are finished at the time when the reading of the tenth original is completed, and starts the image forming operation after the pre-processes are finished. The image forming unit 200 forms an image in which the images of the ninth and tenth originals are arranged side by side, performs the above-mentioned post-processes, and finishes the image forming operation.

In the example in FIG. 8, the pre-processes start at the time when the readings of the third and seventh originals are completed. However, the pre-process may start before the readings of the third and seventh originals are completed.

Although the embodiment shows the example where the pre-processes for the image formation to copy the image of the first original starts in response to the reading of the third original, the control is not limited to this. The pre-processes for the image formation to copy the image of the first original may start in response to the reading of the sixth original.

The feature of the control according to this embodiment is as follows. The image forming unit 200 starts the image formation while the image reading unit 300 continuously reads the originals that are conveyed by the original conveyance unit 400 in response to storing the image data of the predetermined number (the data about the number of sheets for starting image formation) of originals of which images are not formed into the image-processing RAM 159. The image forming unit 200 stops when the image formation for all image data of the originals stored in the RAM 159 is completed.

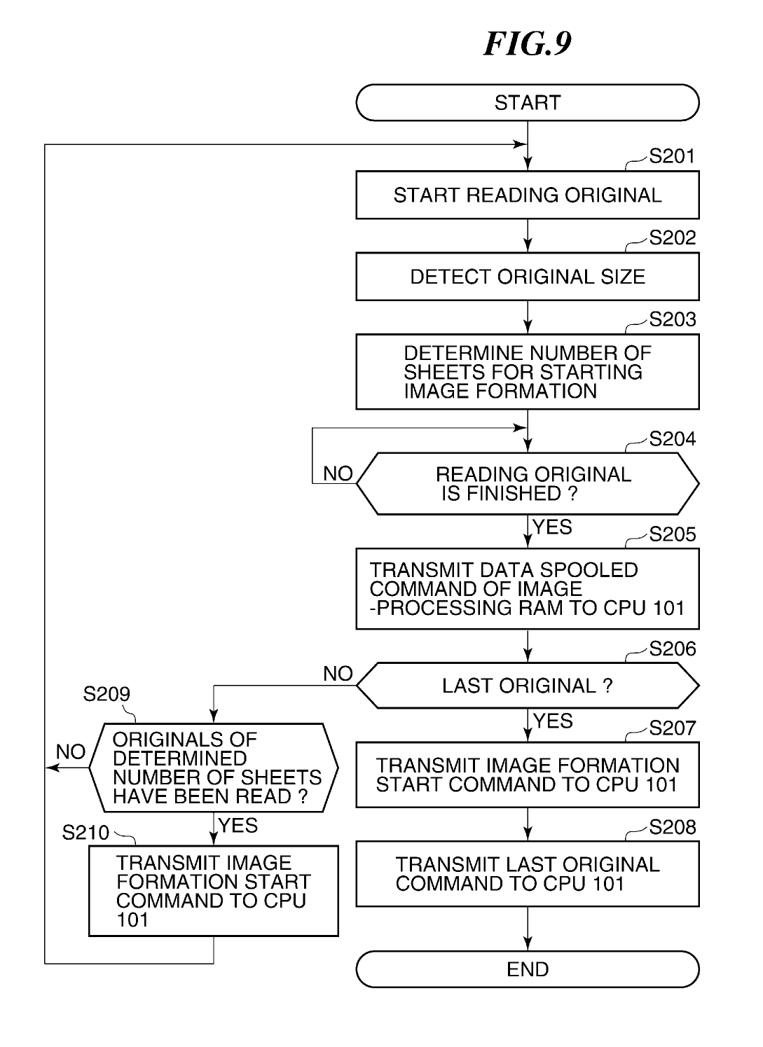

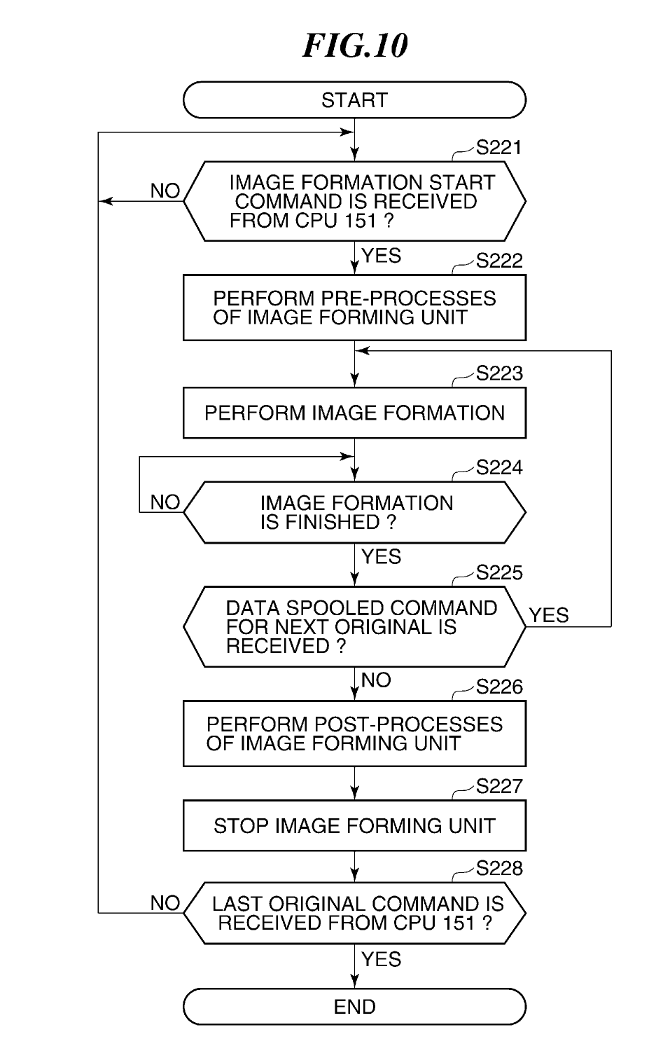

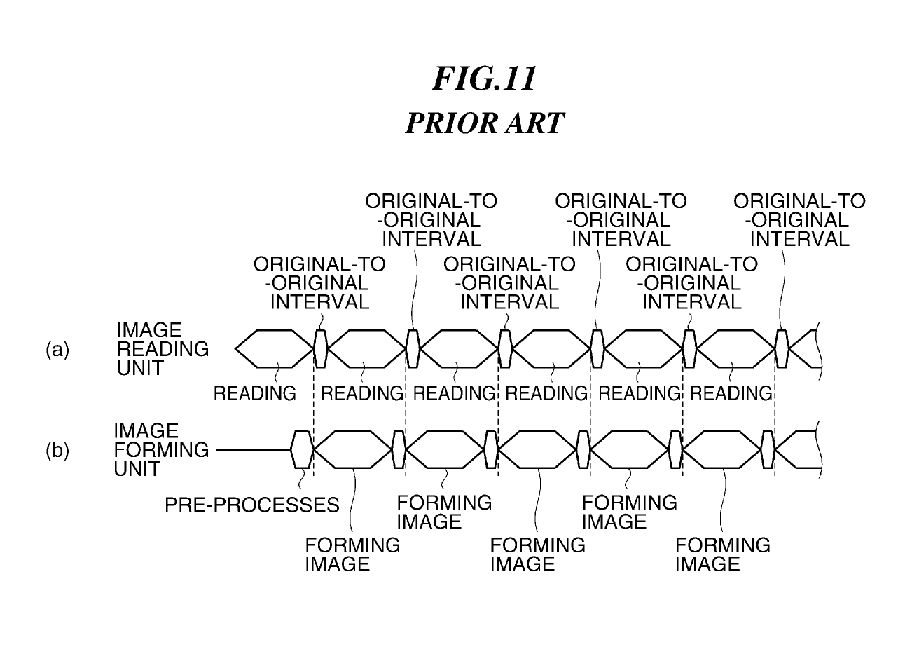

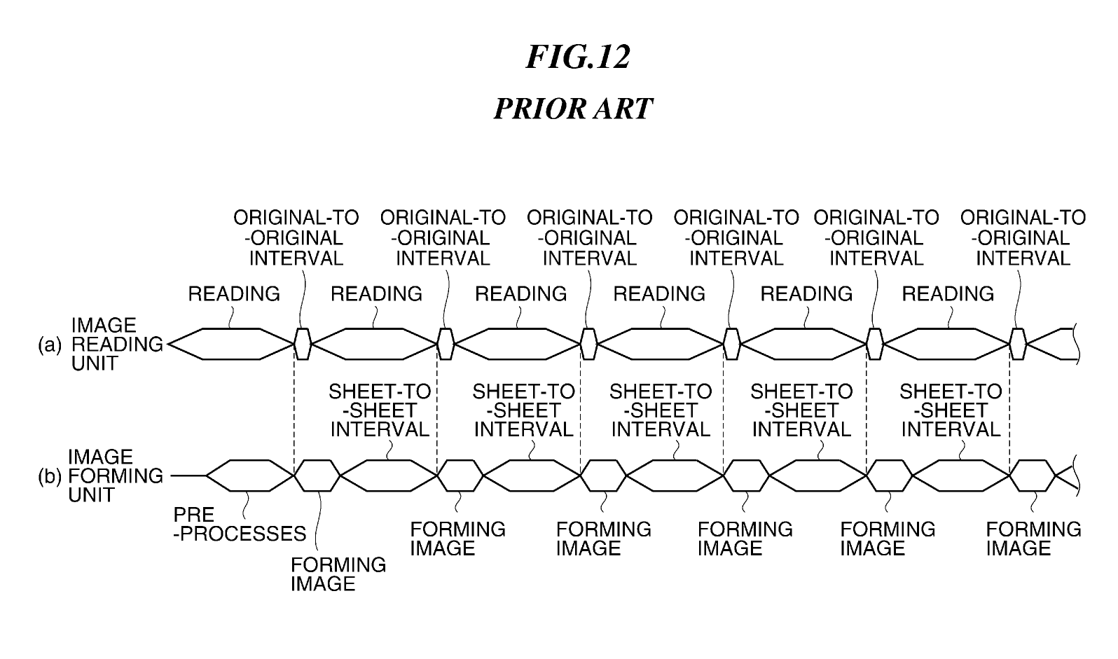

FIG. 9 is a flowchart showing a process executed by the CPU 151 of the image processing controller unit 150 when making color copies by the image forming apparatus according to the second embodiment. FIG. 10 is a flowchart showing a process by the CPU 101 of the control unit 100 when making color copies by the image forming apparatus according to the second embodiment of the present invention.

In FIG. 9, the CPU 151 of the image processing controller unit 150 starts reading originals as follows when the user pushes the copy button in the operation unit 181. The CPU 151 starts feeding and reading the originals set to the original tray 410 of the original conveyance unit 400 by the image reading unit 300 (step S201).

Next, the CPU 151 detects the size of the original according to a time period over which the original passes through the sensor position on the original conveyance path of the original conveyance unit 400 (step S202). Further, the CPU 151 determines the data about the number of sheets for starting image formation by referring the table stored in the ROM 153 using the original size and the copy mode that has set by the user through the operation unit 181 (step S203).

Next, the CPU 151 determines whether the image reading unit 300 has finished the reading of the originals (step S102). When the reading of the originals is completed, the CPU 151 transmits a command showing that the page data of the originals have been spooled to the image-processing RAM 159 to the CPU 101 of the control unit 100 (step S205).

Next, the CPU 151 determines whether the original conveyed by the original conveyance unit 400 is the last original among the plurality of originals set to the original tray 410 based on the output signal from the original detection sensor 412 (step S104). When the read original is not the last one, the CPU 151 determines whether the originals of the number of sheets for starting image formation, which is determined in the step S203, have been read (step S209). That is, the CPU 151 determines whether the image data of the originals of the number of sheets for starting image formation that have not been formed is stored in the RAM 159.

When the originals of the number of sheets for starting image formation have not been read, the CPU 151 conveys a next original succeedingly by the original conveyance unit 400, and reads the original by the image reading unit 300 (step S201). When the originals of the number of sheets for starting image formation have been read, the CPU 151 transmits the image formation start command that shows an image formation start to the CPU 101 of the control unit 100 (step S210), and reads the next original succeedingly by the image reading unit 300 (step S201).

On the other hand, when the read original is the last original, the CPU 151 transmits the image formation start command that shows an image formation start to the CPU 101 of the control unit 100 (step S207). Furthermore, the CPU 151 transmits the last original command showing that the current original is the last one to the CPU 101 of the image processing controller unit 100 (step S208). This finishes the original reading operation.

In FIG. 10, the image forming unit 200 maintains a stopped state until the CPU 101 of the control unit 100 receives the image formation start command transmitted from the CPU 151 of the image processing controller unit 150. When receiving the image formation start command from the CPU 151 of the image processing controller unit 150 (YES in step S221), the CPU 101 executes the pre-processes such as the temperature adjusting control of the fixing unit 16 and the starting of the polygon motor in the image forming unit 200 (step S222). Then, the CPU 101 starts the image formation by the image forming unit 200 (step S223).

Next, the CPU 101 determines whether the image forming unit 200 has finished the image formation to paper based on the above-mentioned image formation start command (step S224). When the image formation is finished, the CPU 101 determines whether a page data spool command for the original that is a next target of the image formation is received from the CPU 151 of the image processing controller unit 150 (step S225).

When the page data spool command is received, the CPU 101 forms the image of the next original succeedingly by the image forming unit 200 (step S223). When the page data spool command is not received, the CPU 101 performs the post-processes such as cleaning of the intermediate transfer belt 8 of the image forming unit 200 (step S226), and stops the image forming unit 200 (step S227).

Next, the CPU 101 determines whether the last original command showing that the current original is the last one has been received from the CPU 151 of the image processing controller unit 150 (step S228). When the last original command is not received, the CPU 101 waits for reception of the next image formation start command from the CPU 151 of the image processing controller unit 150 (step S221).

When receiving the image formation start command from the CPU 151 of the image processing controller unit 150, the CPU 101 executes the pre-processes of the image forming unit 200 again (step S222), and starts the image formation (step S223). The CPU 101 continues the above operation until receiving the last original command from the CPU 151 of the image processing controller unit 150, and completes the image forming operation when the last original command is received.

As described above in detail, the second embodiment has the following functions and effects. The timing to start the image formation during the reading of the originals and the time to halt the operation of the image forming unit are changed according to the settings (the original size, the N-in-1 mode, etc.) in connection with the image formation executed by the image forming unit. Therefore, since the number of starts and the number of stops of the image forming unit, the time of pre-processes and the time of post-processes can be further reduced as compared with the above-mentioned first embodiment, the operation time for other than the image formation can be reduced.

Accordingly, the deterioration of the components (the photosensitive drums, the cleaning blades, etc.) that constitute the image forming unit of the image forming apparatus can be reduced without increasing the size and the cost of the image forming apparatus. This can decrease the exchange frequency of the photosensitive drum cartridge and the toner cartridge, and can increase the life of the intermediate transfer belt. Further, the reductions of the number of starts and the number of stops can reduce the exchange frequencies of motors such as the polygon motor of which the number of starts and the number of stops are limited.

### OTHER EMBODIMENTS

The second embodiment shows the example where the timing to start the image formation during the reading of the originals and the time to halt the operation of the image forming unit are changed according to the original size and the copy modes such as the N-in-1 mode. The data about the number of sheets for starting image formation is similarly stored in the ROM 153 as a table for another copy mode.

For example, the copy mode may be a double-sided copy mode where images are formed in both sides of paper, or an enlarged layout mode where an enlarged image is divided into a plurality of partial images that are formed on a plurality of sheets.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2010-011977, filed on Jan. 22, 2010, and No. 2011-004806, filed on Jan. 13, 2011, which are hereby incorporated by reference herein in their entireties.

What is claimed is:

1. An image forming apparatus in which a processing rate for reading an original is lower than a processing rate for forming an image, comprising:
a reading unit configured to read images of a plurality of sheets of originals continuously;
a storage unit configured to store the images of the originals read by said reading unit;
an image forming unit configured to perform image formation on sheets based on the images stored in said storage unit;
a control unit configured to control driving and stopping of said image forming unit;
wherein said control unit controls said image forming unit so as to complete the image formation for N sheets by repeating an image forming state, in which the image formation for sheets fewer than N is performed continuously, and a stopped state, in which the image formation stops, alternately, when said image forming unit performs the image formation while the reading unit reads N sheets of originals continuously.

2. The image forming apparatus according to claim 1, wherein said image forming unit performs pre-processes for starting image formation before every time when shifting to the image forming state, and performs post-processes for finishing image formation before every time when shifting to the stopped state.

3. The image forming apparatus according to claim 1, wherein said control unit controls said image forming unit so as to shift to the image forming state in response to finish of reading the N-th sheet by said reading unit in the stopped state.

4. An image forming apparatus comprising:
an image forming unit configured to perform image formation on a sheet based on an image of an original read by a reading unit;
a control unit configured to control driving and stopping of said image forming unit;
wherein said control unit controls said image forming unit so as to complete the image formation for N sheets by repeating an image forming state, in which the image formation for sheets fewer than N is performed continuously, and a stopped state, in which the image formation stops, alternately, when said image forming unit performs the image formation while the reading unit reads N sheets of originals continuously.

5. The image forming apparatus according to claim 4, wherein said image forming unit performs pre-processes for starting image formation before every time when shifting to the image forming state, and performs post-processes for finishing image formation before every time when shifting to the stopped state.

6. The image forming apparatus according to claim 4, wherein said control unit controls said image forming unit so as to shift to the image forming state when said reading unit finishes reading the N-th sheet in the stop state.

7. An image forming apparatus in which a processing rate for conveying and reading an original is lower than a processing rate for forming an image, comprising:
an image reading unit configured to read a plurality of sheets of originals continuously;
a storage unit configured to store image data of the image read by said image reading unit;
an image forming unit configured to form an image on a sheet based on the image data; and
a control unit configured to control operations of said image reading unit and said image forming unit,
wherein said control unit starts an operation of said image forming unit when image data of a predetermined number (2 or more) of sheets of originals that have not been formed is stored in said storage unit during the operation for reading a plurality of sheets of originals by said image reading unit, and stops the operation of said image forming unit in response to lack of image data of one sheet of an original that has not been formed in said storage unit after starting the operation, and wherein said control unit repeats the start and the stop of the operation alternately.

8. The image forming apparatus according to claim 7, wherein said control unit changes the predetermined number of sheets according to a size of the originals and settings in connection with the image formation performed by said image forming unit during the operation for reading a plurality of sheets of originals by said image reading unit.

9. The image forming apparatus according to claim 8, wherein the settings in connection with the image formation include at least one of a paper size, the number of images formed in one sheet of paper, a copy magnification, and a both-sided copy.

10. The image forming apparatus according to claim 7, wherein said image forming unit is provided with a photo conductor on which an image is formed, a driving mechanism that drives the photo conductor, an electrostatic charger that charges the photo conductor, a laser scanner that scans the photo conductor charged by the electrostatic charger with a laser beam to form a latent image, and a development device that develops the latent image formed on the photo conductor by the laser scanner, and
wherein said control unit stops the driving mechanism, and stops at least one of drive of the laser scanner, supply of high voltage to the electrostatic charger, and supply of high voltage to the development device, when stopping said image forming unit.

11. A control method for an image forming apparatus that includes an image reading unit that reads a plurality of sheets of originals continuously, a storage unit that stores image data of the image read by the image reading unit, and an image forming unit that forms an image on a sheet based on the image data, in which a processing rate for conveying and reading an original is lower than a processing rate for forming an image, the control method comprising:
a determination step of determining whether image data of a predetermined number (2 or more) of sheets of originals that have not been formed is stored in the storage unit during the operation for reading a plurality of sheets of originals by the image reading unit;
a starting step of starting an operation of the image forming unit when it is determined, in said determination step, that the image data of the predetermined number of sheets of originals is stored; and
a stopping step of stopping the operation of the image forming unit when the storage unit does not store image data of one sheet of an original that has not been formed after starting the operation,
wherein said starting step and said stopping step are repeated alternately during reading a plurality of sheets of originals continuously.
